(19) United States
(12) Patent Application Publication
(10) Pub. No.: US 2021/0034954 A1
(43) Pub. Date: Feb. 4, 2021

(54) MAGNETIC EFFECT ARTIFICIAL INTELLIGENCE SYSTEM

(71) Applicant: CHIA-CHEN CHAN, TAIPEI (TW)

(72) Inventor: CHIA-CHEN CHAN, TAIPEI (TW)

(21) Appl. No.: 16/531,085

(22) Filed: Aug. 4, 2019

(51) Int. Cl. G06N 3/063

(52) U.S. Cl. CPC G06N 3/063

(57) ABSTRACT

A magnetic effect artificial intelligence system composed of at least subsystems of tightly adherent hexagon and stereoscopic magnetic effect artificial neurons, input pre-processing unit, output unit, circuits, interconnections, electronics, electromagnetic components.

### FIELD OF THE INVENTION

The present invention relates to an electromagnetic system of magnetic effect artificial neurons and subsystems that simulates human brains to create artificial intelligence. The present invention relates to the fields of Electronics, Electromagnetism, Computing Theory, Material Science and Cognitive Science.

### BACKGROUND OF THE INVENTION

Cells within the human nervous system, called neurons, communicate with each other. The neuron is the basic working unit of the brain, designed to transmit information to other nerve cells, muscle, or gland cells.

### BRIEF DESCRIPTION OF THE SEVERAL VIEWS OF THE DRAWINGS

FIG. 1 is an example of schematic diagram of the present invention. FIG. 1 illustrates an example of embodiments that consists of three layers of hexagon stereoscopic magnetic effect artificial neurons. Examples of the preferred embodiments of working units within these layers, the topology and the wiring examples of the present invention are shown.

FIG. 2 illustrates an example of the preferred embodiments of the overview of the magnetic effect artificial neuron(s) in the present invention.

FIG. 3 illustrates an example of the preferred embodiments of each layer of the three-layer structure of the present invention.

FIG. 4 illustrates an example of the preferred embodiments of the training mode and related operations of the present invention.

FIG. 5 illustrates an example of the preferred embodiments of the retrieving mode and related operations of the present invention.

FIG. 6 illustrates an example of the preferred embodiments of the training function of the magnetic effect artificial neurons where Hₓ denotes the applied magnetic field strength in x and Bₓ denotes the induced magnetic flux density in x.

### BRIEF DESCRIPTION OF THE INVENTION

The preferred embodiments of this invention relate to magnetic effect artificial neuron system that utilizes magnetic fields. Employing the property of magnetism to simulate human neurons to learn, to store and to retrieve informations.

### DETAIL DESCRIPTION OF THE INVENTION

The disclosed invention trains, stores and retrieves information by means of magnetic fields. The training process is achieved by the buildup of induced magnetic fields; the trained magnetic effect artificial neurons store the information by measuring the magnetic property and retrieved by electronic circuits and components.

Each magnetic effect artificial neuron has three layers of structures made of materials that utilize the magnetic fields and electromagnetic property to train the neuron(s) with feedback signal(s), adjust the training weight(s) relating to the induced remanence. The training of magnetic effect artificial neuron(s) induces magnetization to neighboring neuron(s) also creates influence on training weight(s). Each neuron attaches or very close to adjacent neighbor(s) and forms interactions.

The invention extends to apparatus comprising:

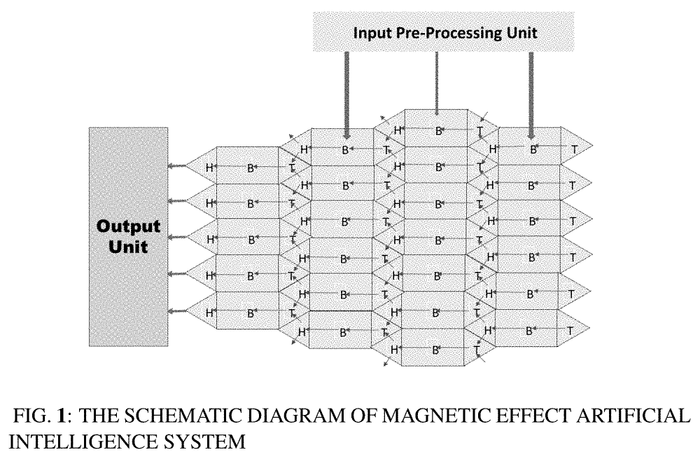

In FIG. 1, H represents Head, B represents Body and T represents Tail.

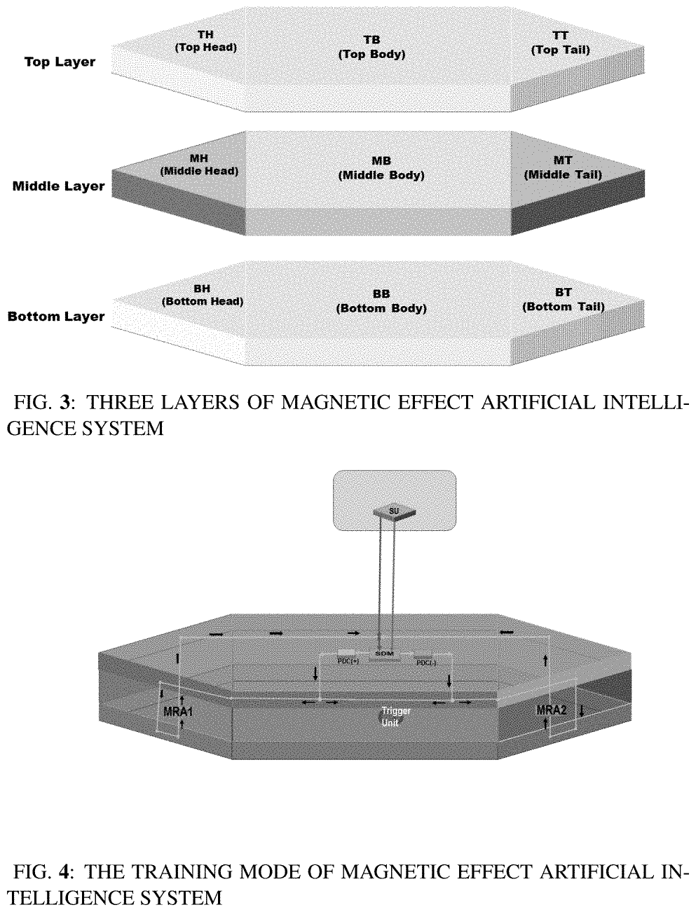

Top Layer: The Top Layer shown in FIG. 3 can be identified as three parts, Top Head(TH), Top Body(TB) and Top Tail(TT), TH, TB. 11 is made of Mu Metal materials and/or similar materials with high magnetic permeability and low magnetic saturation.

Middle Layer: The Middle Layer shown in FIG. 3 can be identified as three parts, Middle Head(MH), Middle Body(MB) and Middle Tail(MT), MH is made of material of ferrite and/or similar materials with high magnetic permeability and high magnetic saturation; MB, is made of Mu Metal materials and/or similar materials with high magnetic permeability and low magnetic saturation. MT is made of material of ferrite and/or similar materials with high magnetic permeability and high magnetic saturation.

Bottom Layer: The Bottom Layer shown in FIG. 3 can be identified as three parts, Bottom Head(BH), Bottom Body(BB) and Bottom Tail(BT), BH, BB. BT is made of Mu Metal materials and/or similar materials with high magnetic permeability and low magnetic saturation.

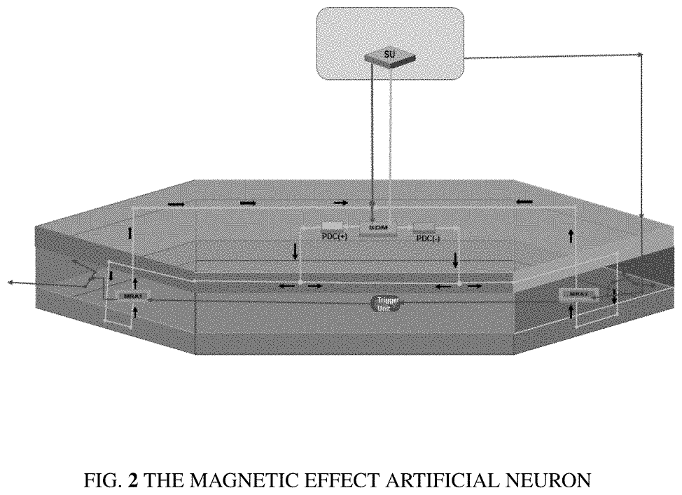

Input pre-processing unit: The input pre-processing unit shown in FIG. 2 is to pre-process the input signal(s). Preferred embodiments of input pre-processing unit include accepting input sources, connecting circuits from SU to SDM of each neuron; converting input signal(s) to be AC signal(s).

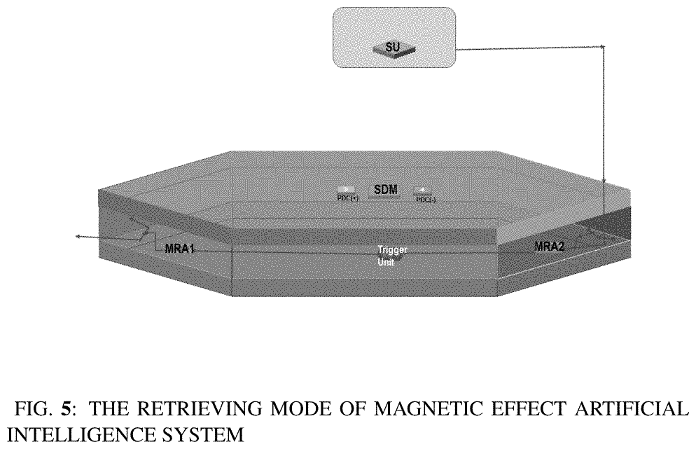

SU: SU in FIG. 2 is an example of preferred embodiments as shunt unit in the invention. SU is inside the input pre-processing unit and determines the modes of the invention to be in training mode or in retrieving mode by judging the input signal(s). If one input signal is presented, the invention is in retrieving mode, the SU will direct the input signal to the working example of retrieving mode shown in FIG. 5. If two input signals are presented, the invention is in training mode, the two input signals: data input signal and training sample signal. data input signal and training sample signal are directed to SDM shown in FIG. 4.

SDM: SDM in FIG. 2 is an example of preferred embodiments as signal differential module. SDM differentiates the two input signals coming from SU while the invention is in training mode. SDM then will output the signal that has larger strength.

When the data input signal is stronger, the output signal is directed to PDC(−),

When the training sample signal is stronger, the output signal is directed to PDC(+),

PDC(+) in FIG. 2 is an example of preferred embodiments of pulsating DC module relates to generating Pulsating DC current with positive polarity.

PDC(−) in FIG. 2 is an example of preferred embodiments of pulsating DC module relates to generating pulsating DC current with negative polarity.

TU in FIG. 2 is an example of preferred embodiments relates to trigger unit that conducts electrical current when the accumulated input signal(s) reaches and/or exceeds its threshold voltage.

MRA in FIG. 2 is an example of preferred embodiments that measures the magnetic field strength and work with corresponding resistance to generates signal gain. There are two MRA in the preferred embodiments: MRA1 and MRA2. MRA1 is inside MH and MRA2 is inside MT

The circuits used in the present invention are coated with insulation materials and/or magnetic shielding materials.

The directions of the electrical current in the invention gives different effect on magnetization: increasing the induced magnetic field or decreasing the induced magnetic field.

Let Sat(x) denote the magnetization saturation of x, then Sat(MH)≥\sqrt{2}Sat(MT)

When The present invention is in Training Mode, both Data Input Signal and Training Sample Signal are fed into SDM as shown in FIG. 4

SDM differentiates the two input signals and output the stronger signal. If data input signal is stronger, it is directed to PDC(−), then the PDC(−) generates Pulsating DC with negative polarity and spilt to both MRA1 and MRA2.

The Pulsating DC travels and splits into MH and MT, changes the induced magnetic strength simulating the preferred embodiments of adjusting training weights; and then feedback to SDMas the new data input signal.

The electric current travels through MH and MT generates magnetic fields around the wire based upon the formula:

$$\begin{matrix}∮ {B}_{x} \cdot d 𝓁 = {μ}_{0} \int \int J \cdot dS + {μ}_{0} {ɛ}_{0} \frac{d}{d t} \int \int E \cdot dS & ( Eq . 1 ) \\ d {B}_{x} = \frac{{μ}_{0}}{4 π} \frac{Id 𝓁 \times \hat{r}}{ {r}^{2}} & ( Eq . 2 ) \\ {M}_{x} = {χ}_{m} {H}_{x} & ( Eq . 3 ) \\ {B}_{x} = {μ}_{0} {H}_{x} + {M}_{x} & ( Eq . 4 ) \\ μ = {μ}_{0} ( 1 + {χ}_{m} ) & ( Eq . 5 )\end{matrix}$$

### Where

J is the total current density
Bₓ is the magnetic flux density
μ₀ is the magnetic constant
ε₀ is the permittivity of free space
μ is the magnetic permeability
Hₓ is the applied magnetic field strength
Xₘ is the volume magnetic susceptibility.
[symbol] is the closed line integral
∫∫ denotes a 2-D surface integral

The MH is very close to the MT of adjacent neurons, and MT is very close to the MH of adjacent neurons as shown in FIG. 1. Interactions of magnetic fields of those MT and MH also exist.

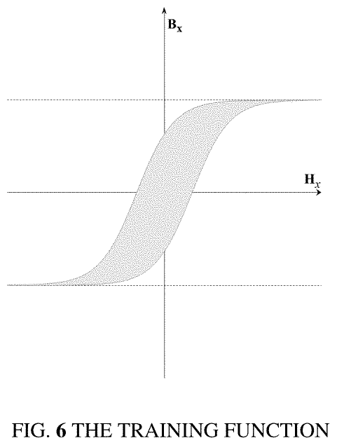

The strength of knowledge/informations in the course of training is built up based on FIG. 6; positive enhancement of the magnetic field strength increases the induced magnetic flux density until positive magnetic saturation is reached, negative enhancement of the magnetic field strength decreases the induced magnetic flux density until negative magnetic saturation is reached.

The training process continues until the process is paused or the differences of two input signals converges to certain amount.

When the training processes are completed or paused, neurons in the disclosed invention contains informations in the MH and MT by means of the induced magnetic field strength.

When the disclosed invention is in retrieving mode, one input signal is presented and goes through the circuit(s) from SU to MRA2 inside MT. and continue to the TU, the TU will fire up when the threshold voltage is reached and/or exceeded. The triggered signal will go to MRA1 and obtains signal gain and continue to propagate to the adjacent neurons through the two wires outreach from the two triangular surfaces until the signal(s) goes to Output Unit.

The Output Unit is an example of preferred embodiments and relates to matching signal(s) to abstract knowledge/informations.

What is claimed is:

1. A system comprising: at least input pre-processing unit, magnetic effect artificial neurons, output unit, circuits, interconnections, electronic, electromagnetic components as shown in FIG. 1.

2. The input pre-processing unit in claim 1 wherein the operations further pre-process the input signal(s). Preferred embodiments of input pre-processing unit include accepting input sources, connecting circuits from SU to SDM of each neuron; converting input signal(s) to be AC signal(s) as shown in FIG. 2

3. The Output Unit in claim 1 wherein the operations further matches signal(s) to abstract knowledge/informations.

4. The magnetic effect artificial neuron in claim 1 wherein the operations further have at least hexagon stereoscopic artificial neuron(s) attach or very close to adjacent neighbor(s) as shown in FIG. 1.

5. The magnetic effect artificial neurons in claim 2 wherein the operations further comprise: at least shunt unit, signal differential module, positive pulsating DC module, negative pulsating DC module, magnetic measurement and amplification, trigger unit, circuits, interconnections.

6. The magnetic effect artificial neurons in claim 2 wherein the operations further comprise three layers of hexagon stereoscopic structure shown in FIG. 3. Each layer has three parts: head, body and tail.

7. The PDC(+) in claim 2 wherein the operations further relates to generating Pulsating DC current with positive polarity.

8. The PDC(−) in in claim 2 wherein the operations further relates to generating Pulsating DC current with negative polarity.

9. The three layers in claim 6 can also be identified as nine parts: top head, top body, top tail, middle head, middle body, middle tail, bottom head, bottom body, bottom tail. Middle head is made of material of ferrite and/or similar materials with high magnetic permeability and high magnetic saturation; middle body is made of mu metal materials and/or similar materials with high magnetic permeability and low magnetic saturation. Middle tail is made of material of ferrite and/or similar materials with high magnetic permeability and high magnetic saturation; top head, top body, top tail, bottom head, bottom body, bottom tail is made of mu metal materials and/or similar materials with high magnetic permeability and low magnetic saturation.

10. Method of the disclosed invention comprises at least: training, storing and retrieving informations.

11. Method of training process in claim 2 comprises: differentiating the data input signal(s) and training sample signal(s), and then pulsating DC with either positive polarity or negative polarity is generated and flow through the designated circuits as shown in FIG. 4 to change the remanence. Signals(s) is adjusted after the work of magnetic measurement and amplification unit and feedback to the signal differential module. The training process continues until the process is paused or the differences of two input signals converges to certain amount. Magnetic effect artificial neurons in the disclosed invention contains informations in the middle head and middle tail by means of the induced magnetic field.

12. Method of retrieving process in claim 2 comprises: input signal goes through the wire(s) from shunt unit to MRA2 inside middle tail. and continue to the trigger unit, the trigger unit will fire up when the threshold voltage is reached and/or exceeded. The triggered signal will go to MRA linside middle head and obtains signal gain and continue to propagate to the adjacent neurons through at least two wires outreaching from the two triangular surfaces until the signal(s) goes to output unit.

13. Method of the disclosed invention of magnetic effect, relates to the proper control of the direction of the flow of electric current.

14. Method of the disclosed invention relates to the closeness of the neurons and thus has interaction on the induced magnetic fields.

15. Method of the disclosed invention has the remanence created inside and/or outside the magnetic effect artificial neuron(s) and/or the fringe fields. The formed interactions among magnetic effect artificial neuron(s) simulates human inspirations

16. Method of the disclosed invention with middle head and middle tail and/or the formed interactions among magnetic effect artificial neuron(s) produces secondary activations and inductions that simulate human subconsciousness.
